(19) United States
(12) Patent Application Publication
(10) Pub. No.: US 2014/0023330 A1
(43) Pub. Date: Jan. 23, 2014

(54) FIBER OPTIC CABLE WITH CELLULOSIC FILLER ELEMENTS

(71) Applicant: Douglas Blew, Mooresville, NC (US)

(72) Inventor: Douglas Blew, Mooresville, NC (US)

(21) Appl. No.: 13/551,142

(22) Filed: Jul. 17, 2012

(51) Int. Cl. G02B 6/44

(52) U.S. Cl. 385/113; 385/109

(57) ABSTRACT

A fiber optic cable includes: a plurality of optical fibers, the fibers divided into a plurality of fiber optic subunits, each of the subunits defining generally a circle having a first diameter; at least one elongate filler element, the filler element comprising a cellulosic material, wherein in end view the filler element defines generally a circle having a second diameter that is substantially the same as the first diameter; and an outer jacket surrounding the optical fiber subunits and the filler element, wherein the total number of fiber optic subunits and fillers elements is at least four. In this configuration, the cable can pass typical flame testing while being manufactured at a lower cost than current cable.

### FIELD OF THE INVENTION

The present invention relates generally to communications cables, and more specifically to fiber optic communications cables.

### BACKGROUND

Fiber optic cables include optical fibers which transmit information in cable television, computer, power, telephone systems, and the like. Typically, fiber optic cables include a plurality of optical fibers housed within one or more protective layers, which are conventionally either plastic “loose tube” buffers (see, e.g., U.S. Patent Publication No. 2005/0281517) or jacketed subunits containing tightly buffered optical fibers (see, e.g., U.S. Pat. No. 6,370,303). The number of fibers included in the cable, and the materials and thicknesses thereof used to form the protective layers, are selected based on the type of application or installation of the cable.

Fiber optic cables often include “fillers” in combination with “active” locations in cable constructions in order to make cables uniform or round. In this definition, “active” locations are fiber-containing positions within a cable construction, whether they be optical fiber-containing plastic loose tube buffers, jacketed subunits containing tight buffered optical fibers, or another fiber optic configuration. One can imagine that assembling three such active positions contained within an elongate cable forms a generally triangular cross-section, four active positions generally resembles a square, and five or more positions begins to define generally a circle, which is often the desired shape of a cable cross-section. These geometries are further complicated by the addition of a central element around which the fiber bearing elements may be stranded. The central element can (a) provide tensile strength, (b) provide columnar strength (anti-buckling), (c) fill a physical void in the construction, (d) actually be an “active” element”, or (e) serve combinations and permutations of any or all of (a)-(d). With this in mind, one skilled in the art will realize that there will be preferred geometries of central and peripheral elements where a specific number of peripheral elements of five or more will in general approximate a round cross-section for an elongate cable.

It is typical and known in the art that when there are fewer than five active peripheral elements, filler elements of similar size (typically elongate rods) are added to occupy the voids in the periphery in order to achieve the minimum of five desired elements to produce a minimally round cable. It is also typical that fillers are added to constructions of more than five active elements when the number of active elements does not adequately fill or complete the geometric spacing of the peripheral elements. If this were not done, there would be undesirable gaps formed around the periphery of the cable which would create voids, generate flat spots, and allow for undesirable movement of the active elements.

### SUMMARY

As a first aspect, embodiments of the invention are directed to a fiber optic cable. The fiber optic cable comprises: a plurality of optical fibers, the fibers divided into a plurality of subunits, each of the subunits defining generally a circle having a first diameter; at least one elongate filler element, the filler element comprising a cellulosic material, wherein in end view the filler element defines generally a circle having a second diameter that is substantially the same as the first diameter; and an outer jacket surrounding the optical fiber subunits and the filler element, wherein the total number of fiber optic subunits and fillers elements is at least four. In this configuration, the cable can pass typical flame testing while being manufactured at a lower cost than current cable, and/or may provide for reduced anti-buckling elements within the cable construction.

As a second aspect, embodiments of the invention are directed to a fiber optic cable, comprising: a plurality of optical fibers, the fibers divided into a plurality of subunits, each of the subunits defining generally a circle having a first diameter; at least one elongate filler element, the filler element comprising a cellulosic material, wherein in end view the filler element defines generally a circle having a second diameter that is substantially the same as the first diameter; and an outer jacket surrounding the optical fiber subunits and the filler element, wherein the total number of fiber optic subunits and fillers elements is at least four. The cellulosic material comprises a fire-retarding agent.

As a third aspect, embodiments of the invention are directed to a fiber optic cable, comprising: a plurality of optical fibers, the fibers divided into a plurality of subunits, each of the subunits defining generally a circle having a first diameter; at least one elongate filler element, the filler element comprising a cellulosic material and a water blocking agent and/or an anti-wicking agent, wherein in end view the filler element defines generally a circle having a second diameter that is substantially the same as the first diameter; and an outer jacket surrounding the optical fiber subunits and the filler element, wherein the total number of fiber optic subunits and fillers elements is at least four.

### BRIEF DESCRIPTION OF THE FIGURES

FIG. 1 is a perspective section view of a fiber optic cable according to embodiments of the invention.

FIG. 2A is a perspective section view of a filler element of the fiber optic cable of FIG. 1.

FIG. 2B is a perspective section view of a filler element according to alternative embodiments of the invention.

FIG. 2C is a perspective section view of a filler element according to additional embodiments of the invention.

FIG. 3 is a perspective section view of a fiber optic cable according to further embodiments of the invention.

### DETAILED DESCRIPTION

The present invention will be described more particularly hereinafter with reference to the accompanying drawings. The invention is not intended to be limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity. Well-known functions or constructions may not be described in detail for brevity and/or clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items. In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

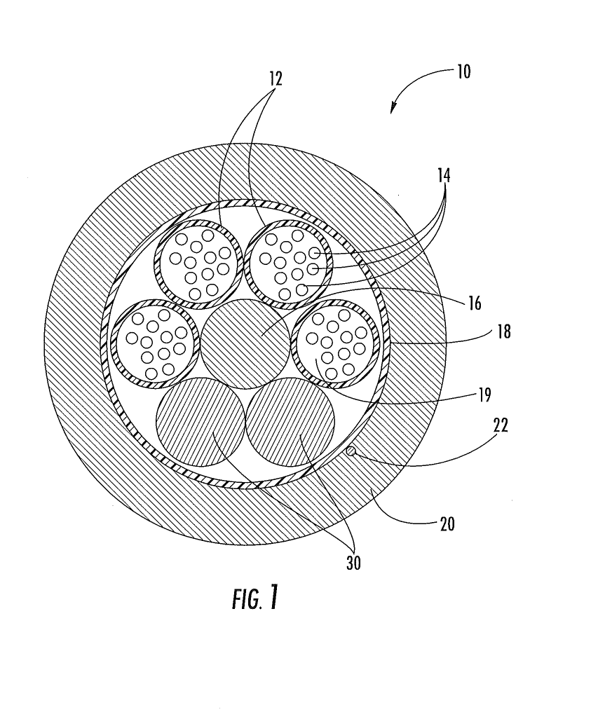

Referring now to FIG. 1, a stranded loose tube cable, designated broadly at 10, is illustrated therein. The cable 10 includes a plurality of buffer tubes 12 (four buffer tubes 12 are shown in FIG. 1), each of which houses multiple optical fibers 14, stranded (i.e., typically wrapped in a shallow helix) about a central strength member 16. A core wrap 18 may be wrapped around the buffer tubes 12. A protective outer jacket 20 is disposed over the core wrap 18. An optional ripcord 22 is provided near the interface of the wrap 18 and the outer jacket 20. Water-blocking gel 19 or other water-blocking material is typically disposed within the buffer tubes 12, and may also be disposed on the exterior of the buffer tubes 14, within the core wrap 18, if desired. These components are described in greater detail below.

The optical fibers 14 are long, slender strands that are capable of carrying and propagating an optical signal. More particularly, optical fibers serve as a medium for transmitting light by virtue of a phenomenon known as total internal reflection. Optical fibers typically have a glass or, on occasion, plastic core that is enveloped by an outer concentric shell or cladding. The cladding is generally made from glass and has a relatively low index of refraction with respect to the core. Because of the difference in the index of refraction between the core and the cladding, light rays striking the cladding at an angle greater than or equal to a critical angle (φ_{c}) will be reflected back into the core at an angle of reflection equal to the angle of incidence. Inasmuch as the angles of incidence and reflection are equal, the light ray will continue to zig-zag down the length of the fiber. If a light ray strikes the cladding at an angle less than the critical angle, however, the ray will be refracted and pass through the cladding, thus escaping the fiber.

Those skilled in this art will recognize that any number of optical fiber constructions may be suitable for use with the present invention. In particular, optical fibers having a thickness between about 200 and 300 microns are often employed and maybe suitable for use in fiber optic cables according to embodiments of the present invention. Other desirable physical and performance properties include those exhibited by single mode fibers with zero water peak (ZWP), which allow transmission in the E band (1360-1460 nm), and high bandwidth multimode fibers. Exemplary optical fibers are “LightScope” ZWP Single Mode or “LaserCore” multimode optical fibers, available from CommScope Inc., Hickory, N.C.

Referring again to FIG. 1, the central strength member 16 provides rigidity to the cable 10. The strength member 16 is typically formed of a dielectric material such as glass-reinforced plastic, or may be formed of a metallic material such as steel. The strength member 16 may also include a polymeric coating in some embodiments.

Additional information regarding the components discussed above is included in U.S. Patent Publication No. 2005/0281517, the disclosure of which is hereby incorporated herein in its entirety.

As can be seen in FIG. 1, the cable 10 also includes two elongate filler elements 30. Prior fillers typically used in the industry are made of plastics, in particular solid or foamed polyethylene. These materials are adequate for use in non-flame rated cables typically found in outdoor applications, but can troublesome for flame-rated cables typically required for indoor use due to their combustibility and smoke generation when ignited. Typical flame, smoke and toxicity ratings are established by International, National and Regional safety and governing bodies. Testing for compliance and listing of these cables is carried out by certified/recognized testing authorities such as Underwriters Laboratories (UL), ETL, CSA, NFPA, etc. Achieving limited flame intensity, limited amount of flame spread, and limited smoke density when a flame-rated cable is burned are all requirements for achieving various indoor flammability and toxicity ratings for flame-rated categories of cables. In order to pass the stringent burn testing of these indoor cables (see, e.g., NFPA 262, Standard Method of Test for Flame Travel and Smoke of Wires and Cables for Use in Air-Handling Spaces), inexpensive commodity plastics (like polyethylene) are normally replaced with much higher cost engineered resins in the fluoropolymer family (e.g., FEP, PVDF and PFA), heavily modified PVC, or other plastics. The use of these considerably more expensive plastics for just the purpose of filling space in the cable drives up the cost of the cables to a significant degree.

To potentially address some of these issues, the filler elements 30 of the cable 10 of FIG. 1 are formed of cellulosic material (such as craft paper, cardboard or crepe/tissue paper) and are sized to be approximately the same diameter and length as a buffer tube 18. As such, the filler elements 30 are able to provide a spacer in the cable 10 that occupies space that would otherwise be occupied by a buffer tube 18, thereby enabling the cable 10 to maintain a desirable configuration (e.g., a generally round configuration as described above, with five or more “sites”, although cables with a total of only four “sites”, including cable subunits and filler elements, are also contemplated). The use of cellulosic materials may reduce the cost of flame-rated cable constructions considerably and/or provide for reduced anti-buckling elements within the cable 10, whether the cable 10 is flame-rated or not.

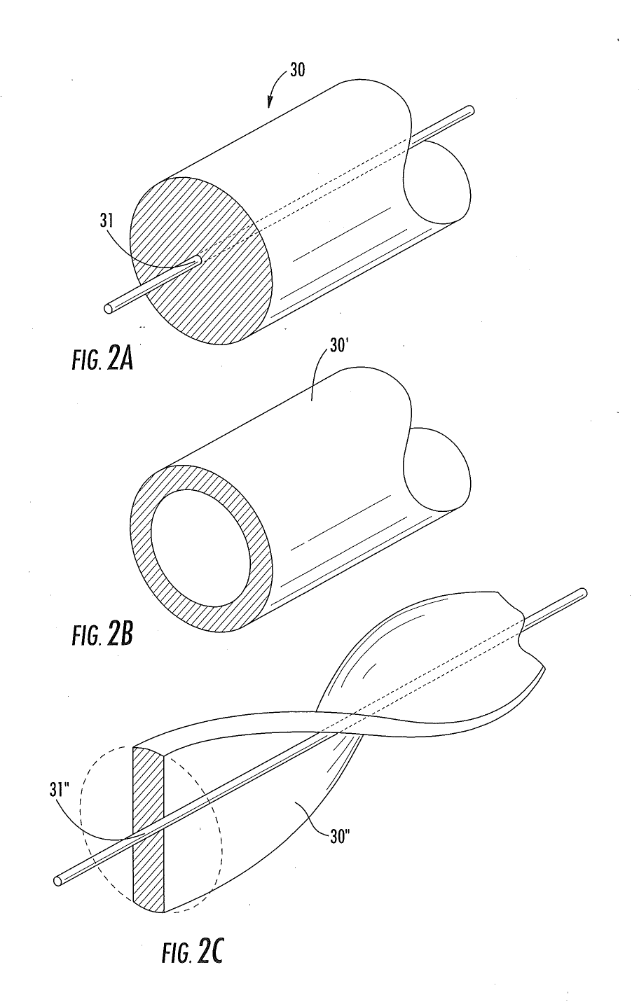

In some embodiments (for example, the filler element 30 shown in FIG. 2A), paper or other cellulosic material may be twisted longitudinally into a tight, substantially solid circular cross-section. In such embodiments, the filler element 30 may include a central spine 31, which is typically formed of fiberglass or another fiber, such as aramid, that can provide strength, stiffness and/or a foundation about which the cellulosic material is twisted or wound. Exemplary materials include paper products 2616-60, 2216-60, 1916-30, 1416-30 and 1216-30 available from PlymKraft Inc., Newport News, Va.

In other embodiments, the filler element may comprise a hollow tube, such as the filler element 30′ of FIG. 2B. In further embodiments, the filler element may comprise paper or cardboard twisted into an open spiral, such as the filler element 30″ of FIG. 2C, which from an end view defines a circular shape (as shown by the dotted line in FIG. 2). The filler element 30″ may include a central spine 31″ of the type discussed above. Other configurations having a generally circular shape in end view may also be employed.

In some embodiments, the filler elements 30 comprise fire-retardant treated paper. In this configuration, the filler element 30 may replace a more expensive engineered plastic filler elements such as are discussed above and commonly employed. An exemplary fire-retardant treated paper is DuoFlame™ paper, available from PlymKraft, Inc. In other embodiments, untreated paper may produce sufficiently low flame, caloric content and/or toxicity to pass some flame-rating testing.

In other embodiments, the filler elements 30 may be treated with or incorporate a water-blocking agent and/or an anti-wicking agent. The use of water-blocking agents may assist the cable 10 in preventing water migration down its longitudinal axis. The use of anti-wicking agents may prevent the wicking of water along the length of the filler element 30. Exemplary water-blocking agents include super absorbent powders, such as Cabloc™ 80HS-A powder, available from Stewart Superabsorbants, Taylorsville, N.C. Exemplary paper with anti-wicking agents include Duo Plym™ paper, available from PlymKraft. An exemplary anti-wicking agent is RUCO-DRY™ water repellent, available from The Rudolf Group, Rock Hill, S.C.

The use of cellulosic materials in filler elements may also provide additional benefits in stress reduction. Fiber optic cables are designed to protect and limit the magnitude of physical stress that is imparted to the actual optical fibers contained within the cable. Stress can be imparted in many ways, such as elongation, compression, bending, and torsion. Stress above a certain magnitude in any of these stress modes can degrade the performance of optical transmission and can also lead to fracture of the optical fiber. Most materials, and particularly plastic materials, shrink when their temperatures decrease according to a defined rate (known as the coefficient of thermal expansion). Most plastics used in optical fiber cable constructions, such as polyethylene and the fluoropolymers mentioned above, tend to shrink at orders of magnitude greater than the glass composition of the optical fiber contained within. The forces that arise from shrinkage are determined by not only the materials involved, but also the mass and/or volume of the materials used. In fiber optic cables, the amount of plastic utilized and the typically large coefficients of thermal expansion can create high shrinkage/contraction forces in a cable as the cable becomes cold. As a result, cables are constructed to minimize the amount of plastic and also encompass mechanical elements which resist the shrinkage forces. These elements are typically called anti-buckling elements and normally consist of fiberglass encased in an epoxy to form stiff elongate members. The additional member(s) resist or offset the shrinkage forces when the cables experience cold temperatures and prevent undue compressive stresses from being transferred to the optical fiber. Anti-buckling elements of this nature are expensive and constrain the design freedom of the cables.

In contrast, cellulosic materials, and in particular paper, have a much lower coefficient of thermal expansion (CTE) than typical plastic materials. For example, cellulosic materials may have a CTE of between about 2.0 and 3.0 μin/in/° F., whereas polyethylene has a CTE of about 111 μin/in/° F. and PVDF has a CTE of about 71 μin/in/° F. Thus, the substitution of cellulosic filler elements for plastic fillers can produce either a reduction in the quantity of anti-buckling material or elements needed in a cable or better performance at lower temperatures with a given amount of anti-buckling. In addition, the nature of cellulosic materials like paper may cause the filler element to crack, fracture, tear or otherwise “give” to relieve compressive stress induced by temperature changes, which can reduce the force applied to the fiber elements 30 on the cable 10 due to temperature changes.

Moreover, the substitution of cellulosic filler elements for plastic filler elements can reduce the weight of the cable. A reduction in weight typically saves on freight cost and improves installation and handling characteristics.

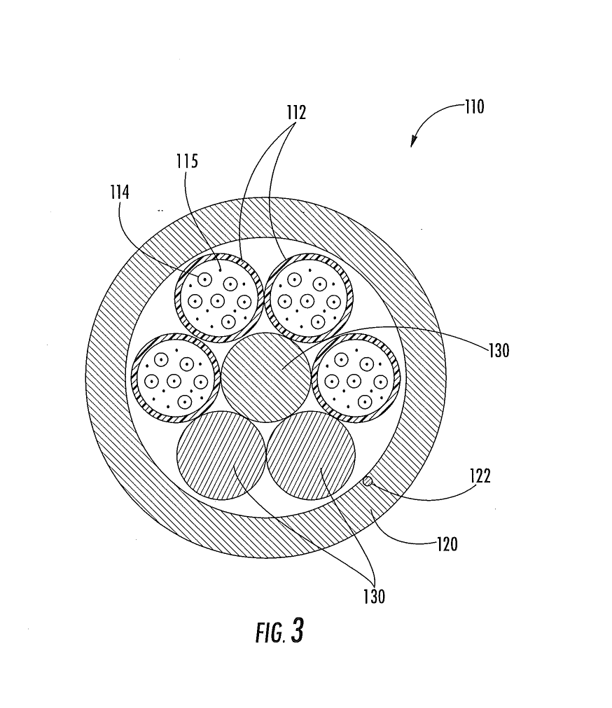

Another fiber optic cable, designated broadly at 110, is shown in FIG. 3. The cable 110 is a tightly buffered cable, and includes tightly buffered optical fibers 114 and aramid yarns 115 within a plurality of jackets 112, each group of fibers and yarns within the jacket forming a subunit. The cable 110 also an outer jacket 120, an optional ripcord 122, and filler elements 130 of the type discussed above in connection with the cable 10. The tightly buffered cable 110 can enjoy the advantages discussed above in connection with the cable 10. The filler elements 130 can provide the same types of advantages in tightly buffered fiber optic cable as in loose tube fiber optic cable.

The invention will now be exemplified by the following example. This example is included to demonstrate embodiments of the present invention and is not intended to be a detailed catalog of all the different ways in which the present invention may be implemented or of all the features that may be added to the present invention. Persons skilled in the art will appreciate that numerous variations and additions to the various embodiments may be made without departing from the present invention. Hence, the following descriptions are intended to illustrate some particular embodiments of the invention, and not to exhaustively specify all permutations, combinations and variations thereof.

### EXAMPLE

Table 1 below includes property information regarding exemplary cellulosic materials and compares them to materials used in prior filler elements.

TABLE 1

| | | | Combustion | Combustion |
|---|---|---|---|---|
| | Usage Rate | Mass | Energy | Energy - Use |
| Material | (ft/lb) | (lb/1000 ft) | BTU/lb | (BTU/1000 ft) |
| 0.109″ | 430 | 2.32 | 4,925 | 11,426 |
| DuoPlym | | | | |
| (moisture | | | | |
| resistant) | | | | |
| 0.109″ | 430 | 2.35 | 5,500 | 12,925 |
| DuoFlame | | | | |
| (flame | | | | |
| resistant) | | | | |
| 2616-60 | 450 | 2.22 | 4,725 | 10,500 |
| 1916-30 | 675 | 1.48 | 4,760 | 7,050 |
| 1216-30 | 960 | 1.04 | 5,030 | 5,241 |
| Polyethylene | 313 | 3.20 | 20,000 | 64,000 |
| PVDF | 310 | 3.22 | 5,800 | 18,676 |

Table 1 demonstrates that multiple cellulosic materials can produce less combustion energy than (a) polyethylene material typically used in non-flame-rated cables and (b) PVDF material often used in flame-rated cables.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A fiber optic cable, comprising:
a plurality of optical fibers, the fibers divided into a plurality of fiber optic subunits, each of the subunits defining generally a circle having a first diameter;
at least one elongate filler element, the filler element comprising a cellulosic material, wherein in end view the filler element defines generally a circle having a second diameter that is substantially the same as the first diameter; and
an outer jacket surrounding the optical fiber subunits and the filler element;
wherein the total number of fiber optic subunits and fillers elements is at least four.

2. The fiber optic cable defined in claim 1, wherein the cellulosic material comprises paper.

3. The fiber optic cable defined in claim 1, wherein the filler element is solid in cross-section.

4. The fiber optic cable defined in claim 1, wherein the at least one filler element is a plurality of filler elements.

5. The fiber optic cable defined in claim 1, wherein the fiber optic subunits and the filler element define generally a circle in cross-section.

6. The fiber optic cable defined in claim 1, further comprising a strength element.

7. The fiber optic cable defined in claim 1, wherein the filler element comprises a water-blocking agent and/or an anti-wicking agent.

8. The fiber optic cable defined in claim 1, wherein the fiber optic subunits comprise buffer tubes enclosing optical fibers therein.

9. The fiber optic cable defined in claim 1, wherein the optical fibers are tightly buffered optical fibers.

10. The fiber optic cable defined in claim 1, wherein the filler element comprises a central spine.

11. A fiber optic cable, comprising:
a plurality of optical fibers, the fibers divided into a plurality of fiber optic subunits, each of the subunits defining generally a circle having a first diameter;
at least one elongate filler element, the filler element comprising a cellulosic material, wherein in end view the filler element defines generally a circle having a second diameter that is substantially the same as the first diameter; and
an outer jacket surrounding the fiber optic subunits and the filler element, wherein the total number of fiber optic subunits and fillers elements is at least four;
wherein the cellulosic material comprises a fire-retarding agent.

12. The fiber optic cable defined in claim 11, wherein the cellulosic material comprises paper.

13. The fiber optic cable defined in claim 11, wherein the filler element is solid in cross-section.

14. The fiber optic cable defined in claim 11, wherein the at least one filler element is a plurality of filler elements.

15. The fiber optic cable defined in claim 11, wherein the fiber optic subunits and the filler element define generally a circle in cross-section.

16. The fiber optic cable defined in claim 11, further comprising a strength element.

17. The fiber optic cable defined in claim 11, wherein the filler element comprises a water-blocking agent and/or an anti-wicking agent.

18. The fiber optic cable defined in claim 11, wherein the fiber optic subunits comprise buffer tubes enclosing optical fibers therein.

19. The fiber optic cable defined in claim 11, wherein the optical fibers are tightly buffered optical fibers.

20. The fiber optic cable defined in claim 11, wherein the filler element comprises a central spine.

21. A fiber optic cable, comprising:
a plurality of optical fibers, the fibers divided into a plurality of fiber optic subunits, each of the subunits defining generally a circle having a first diameter;
at least one elongate filler element, the filler element comprising a cellulosic material and a water-blocking agent and/or an anti-wicking agent, wherein in end view the filler element defines generally a circle having a second diameter that is substantially the same as the first diameter; and
an outer jacket surrounding the fiber optic subunits and the filler element.
